(19) United States
(12) Patent Application Publication
(10) Pub. No.: US 2024/0208877 A1
(43) Pub. Date: Jun. 27, 2024

(54) METHOD FOR METALLIZING THE INNER FACE OF A TUBE MADE OF A CERAMIC OR A CERAMIC MATRIX COMPOSITE

(71) Applicant: COMMISSARIAT A L'ENERGIE ATOMIQUE ET AUX ENERGIES ALTERNATIVES, Paris (FR)

(72) Inventors: Christophe LORRETTE, Montlhery (FR); Marie DUMERVAL, Villemoisson-sur-orge (FR); Guillaume NONY, Morsang-sur-orge (FR)

(21) Appl. No.: 18/391,948

(22) Filed: Dec. 21, 2023

(30) Foreign Application Priority Data
Dec. 23, 2022 (FR) 2214402

(51) Int. Cl. C04B 41/51; C04B 35/565; C04B 35/80

(52) U.S. Cl. CPC C04B 41/5133; C04B 35/565; C04B 35/80; C04B 2235/3826; C04B 2235/5244; C04B 2235/94

(57) ABSTRACT

A method for metallizing the inner face of a tube made of a ceramic or a ceramic matrix composite, including at least a step of plating a metallic tube on the inner face of the ceramic or ceramic matrix composite tube, and wherein the plating comprises a creep of the metallic tube by applying to this tube an internal pressure and a heating, the creep resulting in an increase in the outer diameter of the metallic tube until the outer face of the metallic tube presses against the inner face of the ceramic or ceramic matrix composite tube. A method for manufacturing a tubular nuclear fuel cladding implementing the metallization method.

### CROSS-REFERENCE TO RELATED APPLICATIONS

This application claims priority from French Patent Application No. 2214402 filed on Dec. 23, 2022. The content of this application is incorporated herein by reference in its entirety.

### TECHNICAL FIELD

The invention relates to the field of the metallization of tubular elements.

More specifically, the invention relates to a method for metallizing—the term “metallizing” being taken here to mean associating a metallic layer with—the inner face of a tube based on a ceramic, i.e. consisting of a ceramic or a ceramic matrix composite, this method making it possible in particular to obtain a cohesion between the inner face of the tube and the metallic layer which is associated with this inner face.

The invention finds, firstly, an application in the nuclear industry for cladding nuclear fuels and, more particularly, E-ATF (Enhanced Accident Tolerant Fuel) nuclear fuels intended for light-water reactors such as pressurised water reactors (or PWRs) and boiling water reactors (or BWRs), but also for cladding other types of nuclear fuels once this cladding complies with a multi-layer tubular design with a layer based on a ceramic of which the inner face is associated with a metallic layer.

Also, the invention relates to a method for manufacturing a tubular nuclear fuel cladding implementing the metallization method.

However, the metallization method according to the invention can also be implemented in other industrial fields such as in the manufacture of tubular tanks intended to contain high added-value products (such as liquid or solid hydrogen, propellant type solid fuels, etc.) and, more generally, in the manufacture of tubular elements intended to comprise a layer based on a ceramic of which the inner face is associated with a metallic layer (such as lining).

### PRIOR ART

Following the Fukushima-Daiichi nuclear accident in 2011, numerous national and international research programmes have been launched on the design and development of novel nuclear fuel element concepts, referred to as E-ATF, more robust in accident scenarios than current nuclear fuel elements.

These research programmes relate in particular to novel nuclear fuel cladding solutions in the knowledge that the expected properties for a cladding material are in particular (but not only) a tightness capable of guaranteeing a containment of the fissile material and fission products under all circumstances (normal, incident or accident) and a capability to evacuate towards the heat-transfer fluid the heat produced by the nuclear reactions, again under all circumstances.

One of the cladding solutions currently under study is based on the use of silicon carbide composite matrix and fibers materials, more simply referred to as SiC_{f}/SiC. These materials are, indeed, highly attractive in particular due to their remarkable performances in terms of oxidation resistance in air, mechanical strength and dimensional stability up to very high temperatures (i.e., even above 1600° C.), which indicates the possibility of significantly increasing, in accident scenarios, the safety margins at fusion and, thereby, the response times to secure the reactor core.

However, despite this attractiveness, the integration in reactors of SiC_{f}/SiC ceramic cladding fuel elements is not expected for many years because substantial technological barriers still need to be lifted. One of these barriers concerns the inability of a ceramic to retain tightness—or, at the very least, the inability to demonstrate this property—with respect to the heat-transfer fluid but also with respect to the fissile material and fission products, under all circumstances and throughout its lifetime.

Also, to prevent this loss of tightness, two multilayer cladding designs have been envisaged wherein a layer made of an SiC_{f}/SiC composite, capable of ensuring the robustness of the cladding under accident conditions, is associated with a layer which is either made of monolithic SiC or metallic and which is intended to guarantee the containment of the fissile material and tightness to fission products under all circumstances.

In the case of an “all ceramic” cladding, the monolithic SiC layer on which the tightness function is based is generally prepared in situ at the same time as the layer made of SiC_{f}/SiC composite by a gaseous process method, or by sintering a powder. While this design results in a continuum of material favourable for a thermal transfer, experience shows that the cladding thus obtained is fragile and loses its tightness by microcracking once the ceramic attains its yield strength which is the order of 0.1% under service or accidental load.

For this reason, it was decided by the Commissariat à l'énergie atomique et aux energies alternatives (CEA), to which the inventors belong, to prioritise a “composite/metal” hybrid cladding which indicates deformation levels greater than 1% with tightness retention.

During the manufacture of such a cladding, it is appropriate for the method implemented to associate the two layers, SiC_{f}/SiC composite and metallic respectively, to result in a cohesion between these layers, this cohesion guaranteeing an optimal heat transfer. Indeed, the negative consequences of a lack of cohesion are known from the literature (see L. Duquesne, Caractérisation thermique de structures composites SiC/SiC tubulaires pour applications nucléaires. Génie des procédés. École nationale supérieure d'arts et métiers—ENSAM, 2015, hereinafter reference [1]).

Currently, in the absence of a probative alternative, the reference experimental method at the CEA for producing a “composite/metal” E-ATF cladding, wherein the metallic layer is located on the inner face of the SiC_{f}/SiC composite layer, is the “push” fit method with a sliding tolerance. This method is aimed at associating two previously prepared unit tubular components with an adjusted radial gap (<50 μm) under the effect of an axial force (unpublished data).

A method which would consist of infiltrating for several hundred hours a fibrous preform with a CVI (Chemical Vapour Infiltration) type gaseous process directly onto a metallic substrate is not suitable. Indeed, these infiltration conditions, which use chlorinated precursors carried by dihydrogen used as a carrier gas in a furnace heated to 1000° ° C., are applicable to refractory metals such as tantalum or niobium which are capable of being used for the manufacture of fuel claddings intended for reactors operating with a heat-transfer fluid other than water (helium-cooled fast neutron reactors for example) but are unacceptable in the case of the metallic materials currently retained for the manufacture of “composite/metal” E-ATF claddings and intended for light water nuclear reactors such as zirconium alloys and titanium.

Finally, a hydroforming association method, consisting of plastically deforming a metallic tube under the action of a pressurised fluid, typically a water-oil emulsion, at ambient temperature to plating it on the inner face of an SiC_{f}/SiC composite tube, was very quickly abandoned.

Indeed, besides the fact the method is accompanied by an unavoidable elastic return of the metal or metal alloy opposing the establishment of a cohesion between the two layers, it requires very high pressure conditions liable to irreversibly damage the composite layer.

In view of the above, the inventors set themselves the aim of providing a method which makes it possible to metallize the inner face of a tube based on a ceramic and, in particular, of a tube made of an SiC_{f}/SiC type composite for producing a “composite/metal” E-ATF cladding and which is, as a general way, free from all the drawbacks exhibited by the methods proposed to date for associating a metallic layer with the inner face of a tube based on a ceramic.

### DISCLOSURE OF THE INVENTION

The aim of the invention is precisely that of providing such a method.

Thus, the invention relates, firstly, to a method for metallizing the inner face of a tube made of a ceramic or a ceramic matrix composite, which comprises at least a step of plating a metallic tube on the inner face of the ceramic or ceramic matrix composite tube, and which is characterised in that the plating comprises a creep of the metallic tube by applying to this tube an internal pressure and a heating, the creep resulting in an increase in the outer diameter of the metallic tube until the outer face of this tube plates on the inner face of the ceramic or ceramic matrix composite tube.

Hereinabove and hereinafter, “metallic tube” denotes a tube consisting of a metal or a metal alloy whereas “ceramic matrix composite” denotes a material composed of a ceramic reinforced with a fibrous reinforcement, this reinforcement optionally, in particular, itself consisting of ceramic fibers.

Moreover, we recall that creep corresponds to an irreversible deformation of a material under the effect of constant stress applied thereto for a sufficient time to obtain this deformation.

Thus, in the method of the invention, the creep enables the metallic tube to deform radially until its outer face plates on the inner face of the ceramic or ceramic matrix composite tube, irreversibly such that any elastic return of the metal or metal alloy forming the metallic tube is impossible. A bilayer structure, characterised by a cohesion between the metallic layer and the ceramic or ceramic matrix composite layer, is thus obtained with, as a bonus, an optimal thermal transfer.

As stated above, the creep-induced plating of the metallic tube comprises the application to this tube of an internal pressure and a heating.

Preferably, the internal pressure is applied to the metallic tube uniformly by isostatic pressurisation of this tube, i.e. equal in all directions such that the creep of the metallic tube is the same at all points of this tube.

Typically, this isostatic pressurisation is carried out by an intake of a gas, which is, preferably, an inert gas such as helium or argon to prevent any risk of reaction or interaction with the metal or metal alloy forming the metallic tube but other gases may also be suitable according to the nature of this metal or this metal alloy and the end sought for the tubular structure obtained after metallization.

Regarding the heating of the metallic tube, this is advantageously carried out by Joule effect, this effect optionally being induced by circulating an electric current in the metallic tube—which enables a rapid heating of the metallic tube and a precise control of the temperature to which it is brought—or by electromagnetic induction, by direct coupling with the metallic tube.

It is also possible to subject the metallic tube to a pre-pressurisation then heating in a furnace the whole formed by this tube and the ceramic or ceramic matrix composite tube, the metallic tube then being closed at its two ends.

Preferably, the pressure and temperature conditions to be applied to the metallic tube to obtain its creep as well as the application time of these conditions will be chosen in such a way that they make it possible to radially deform this tube sufficiently so that its outer face plates on the inner face of the ceramic or ceramic matrix composite tube and, thus, ensures a cohesion between the two faces but:
on one hand, without modifying the crystalline structure and the crystallographic texture of the metal or the metal alloy forming the metallic tube (thus, an excessively high temperature can result in an enlargement of the grains of the metal or metal alloy), and
on the other, without damaging the ceramic or ceramic matrix composite tube, which means that the radial stress induced by the pressure level applied to the metallic tube must not exceed the damage threshold of the ceramic or ceramic matrix composite, this threshold corresponding substantially to the yield strength of the ceramic or ceramic matrix composite.

These conditions will therefore be chosen according to the properties of the metal or metal alloy forming the metallic tube and those of the ceramic or composite forming the ceramic or ceramic matrix composite tube but also according to the geometry of these tubes and, in particular, the thickness of the wall of the metallic tube as well as the space, or radial gap, initially existing between the outer face of the metallic tube and the inner face of the ceramic or ceramic matrix composite tube and to be filled by the plating.

In this regard, it is specified that the temperature and pressure conditions to be applied to the metallic tube as well as the application time of these conditions can be determined theoretically by means of a creep law such as that described by T. Forgeron et al. (Experiment and Modelling of Advanced Fuel Rod Cladding Behavior Under LOCA Conditions: Alpha-Beta Phase Transformation Kinetics and EDGAR Methodology, Zirconium in the Nuclear Industry: Twelfth International Symposium, ASTM STP, 2000, 1354, 256-278; hereinafter reference [2]), then verified or, if required, refined experimentally by performing creep tests, by means of a creep bench, on test specimens representative of the two tubes to be associated.

Within the scope of the invention, the metallic tube is, preferably, made of zirconium, titanium or an alloy thereof, preference however being given to a zirconium alloy.

If the metallic tube is made of a zirconium alloy, the temperature to which this tube is brought is advantageously between 0.25 T_{f} and 0.5 T_{f} and, preferably, between 0.4 T_{f} and 0.5 T_{f}, T_{f} being the absolute melting point of the zirconium alloy forming this tube. Furthermore, as previously mentioned, the pressure applied to the zirconium alloy tube is suitably chosen so that the radial stress induced by this pressure is sufficient to radially deform this tube, while being below the yield strength of the ceramic or ceramic matrix composite.

Examples of such a zirconium alloy can be Zircaloy-4, Zirlo™ or M5™ alloy, these alloys having numerous advantages for an application of the metallization method of the invention to the cladding of nuclear fuels intended for light water nuclear reactors, such as a very low absorption of thermal neutrons, satisfactory mechanical properties and a very good corrosion resistance even under high temperature conditions.

However, it can be envisaged to provide that the metallic tube can be made of a metal or metal alloy other than those cited above such as a steel, a nickel-based alloy, an iron-chromium-aluminium type alloy, a high-entropy alloy consisting of several metallic elements in equimolar proportion and, more generally, any metal or metal alloy capable of being deformed by creep and being compatible from a thermochemical point of view with the ceramic of the tube on the inner face of which the metallic tube must be plated.

According to the invention, the ceramic or ceramic matrix composite tube is, preferably, either a tube consisting of SiC if it is made of ceramic or a tube made of SiC reinforced with ceramic fibers if it is made of ceramic matrix composite, these ceramic fibers optionally in particular being carbon fibers, SiC fibers or oxide fibers, particular preference being given to SiC fibers.

Examples of SiC fibers that can be used are in particular Nicalon™, Hi-Nicalon™ and Hi-Nicalon™ type S fibers produced by NGS Advanced Fibers or Tyranno™, Tyranno™ SA, Tyranno™ SA3 or Tyranno™ SA4 fibers produced by UBE Industries, Ltd.

Of these, particular preference is given to Hi-Nicalon™ type S and Tyranno™ SA3 and Tyranno™ SA4 fibers due to their purity, their crystallinity and their quasi-stoichiometric composition (Si/C ratio≈1) which gives them a very particular stability in neutron irradiation.

Moreover, as known per se, the fibers of the reinforcement can be coated with an interphase material, advantageously pyrolytic carbon, the main role of which is to ensure an accommodating load transfer under mechanical stress and to prevent sudden ruptures beyond the elastic range of the SiC matrix.

According to the invention, the method advantageously furthermore comprises, before the plating step, insertion of the metallic tube into the ceramic or ceramic matrix composite tube. This insertion can be carried out, for example, by simply sliding the metallic tube into the ceramic or ceramic matrix composite tube. It goes without saying that the metallic tube has an outer diameter less than the inner diameter of the ceramic or ceramic matrix composite tube, which enables this insertion.

The metallization method according to the invention proved to be particularly well suited to the manufacture of tubular nuclear fuel claddings in that it offers the possibility of plating a metallic tube, in particular made of a zirconium alloy, on the inner face of a ceramic matrix composite tube, in particular based on SiC, and, on the one hand, without a risk of any elastic return of the metallic tube and, on the other, without using CVI furnace pass operations liable to degrade the properties of the metallic layer.

Thus, the invention also relates to a method for manufacturing a tubular nuclear fuel cladding, this cladding comprising a layer made of ceramic matrix composite of which the inner face is coated with a metallic layer, which is characterised in that it comprises at least the implementation of the metallization method as defined above.

Preferably, the cladding is a bilayer cladding, i.e. the ceramic matrix composite layer forms the outer face of the cladding whereas the metallic layer forms the inner face of the cladding.

However, it goes without saying that the cladding can be other than bilayer with the presence of one or more additional layers either on the outer face of the ceramic matrix composite layer or on the inner face of the metallic layer.

Typically, the tubular cladding has a circular cross-section but other geometries are also possible such as an oval, rectangular, square or hexagonal cross-section.

Preferably, the ceramic matrix composite layer of the cladding is a layer made of silicon carbide matrix and silicon carbide fibers whereas the metallic layer of this cladding is a layer made of a zirconium alloy such as Zircaloy-4, Zirlo™ or M5™ alloy.

According to the invention, the cladding is, preferably, a nuclear fuel cladding for a light water nuclear reactor and, in particular, for a pressurised water reactor or boiling water reactor, preferably for a pressurised water reactor, in which case the cladding typically has a length of 4 metres, a wall of a thickness of 600 μm, the layer made of silicon carbide matrix and silicon carbide fibers then having, preferably, a thickness of 400 μm to 500 μm whereas the metallic layer has, preferably, a thickness of 100 μm to 200 μm.

The metallization method according to the invention is also well suited for the manufacture of tubular liquid or solid gas tanks, for example of hydrogen, or tubular propellant tanks, of which the wall comprises a layer made of a ceramic or a ceramic matrix composite of which the inner face is coated with a metallic layer.

Thus, the invention also relates to a method for manufacturing such a tank, which is characterised in that it comprises at least the implementation of the metallization method as defined above.

Preferably, the tank wall is a bilayer wall, i.e. the ceramic or ceramic matrix composite layer forms the outer face of the tank and the metallic layer forms the inner face of the tank.

Other features and advantages of the invention will emerge upon reading the following additional description which makes reference to the appended figures.

It goes without saying that this additional description is given only as an illustration of the subject matter of the invention and should in no way be interpreted as a limitation of this subject matter.

### BRIEF DESCRIPTION OF THE FIGURES

FIG. 1 is a schematic representation of the principle of creep-induced plating implemented in the method according to the invention, part A showing, in a longitudinal sectional view, a metallic tube in a ceramic or ceramic matrix composite tube before the metallic tube has been deformed by creep whereas part B shows the bilayer tubular structure obtained after creep deformation of the metallic tube; in this figure, the dimensions and relative proportions of the tubes are not representative of those that can be exhibited by the tubes in an actual scenario of implementation of the method according to the invention, for readability purposes.

FIG. 2, parts A and B, corresponds to two images taken by tomography of a bilayer tubular structure as illustrated in part B of FIG. 1, part A showing a segment of the structure in a cross-sectional view whereas part B shows a segment of the structure in a longitudinal sectional view.

FIG. 3 illustrates the results of a parametric search on the creep conditions capable of enabling a radial deformation of 0.70% by creep of Zircaloy-4 test specimen in an SiC_{f}/SiC composite test specimen so as to fill the radial space initially existing between these test specimens; in this figure, the y-axis corresponds to the percentage of circumferential deformation, noted Ee, of the Zircaloy-4 test specimen whereas the x-axis corresponds to the application time, noted t and expressed in seconds, of the pressure and temperature conditions.

FIG. 4 illustrates the results of a profilometry metrological inspection aimed at assessing the radial deformation of tubular Zircaloy-4 test specimens before and after creep tests carried out on these test specimens alone; in this figure, the y-axis corresponds to the outer diameter of the test specimens, noted Ø and expressed in mm, whereas the x-axis corresponds to the longitudinal range of the radial deformation, noted E and expressed in mm, of these test specimens.

FIG. 5 illustrates the results of a profilometry metrological inspection aimed at assessing, before and after a first series of creep tests, the radial deformation of tubular Zircaloy-4 test specimens in tubular SiC_{f}/SiC composite test specimens; in this figure, the y-axis corresponds to the outer diameter, noted Ø and expressed in mm, of the Zircaloy-4 test specimens whereas the x-axis corresponds to the longitudinal range of the radial deformation, noted E and expressed in mm, of these test specimens.

FIG. 6 is a similar figure to FIG. 5 but for a second series of creep tests carried out with different creep conditions.

### DETAILED DESCRIPTION OF PARTICULAR MODES OF IMPLEMENTATION

### I—Creep-Induced Plating Principle:

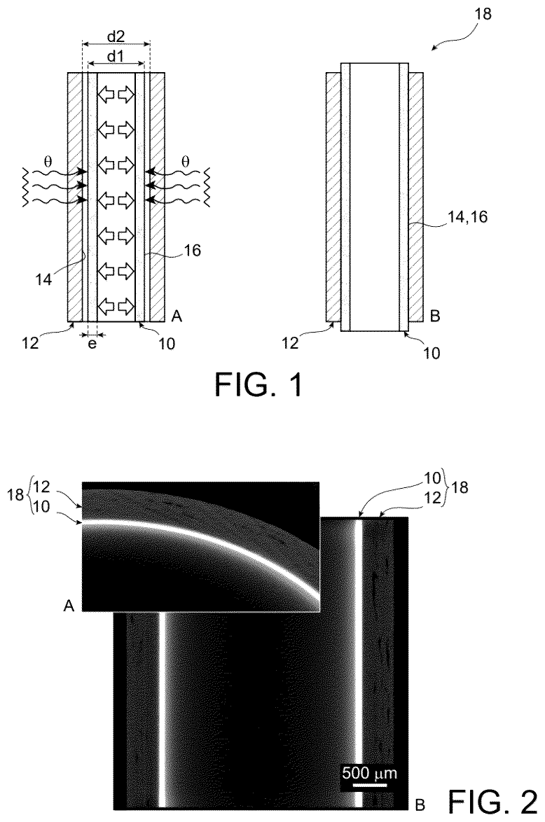

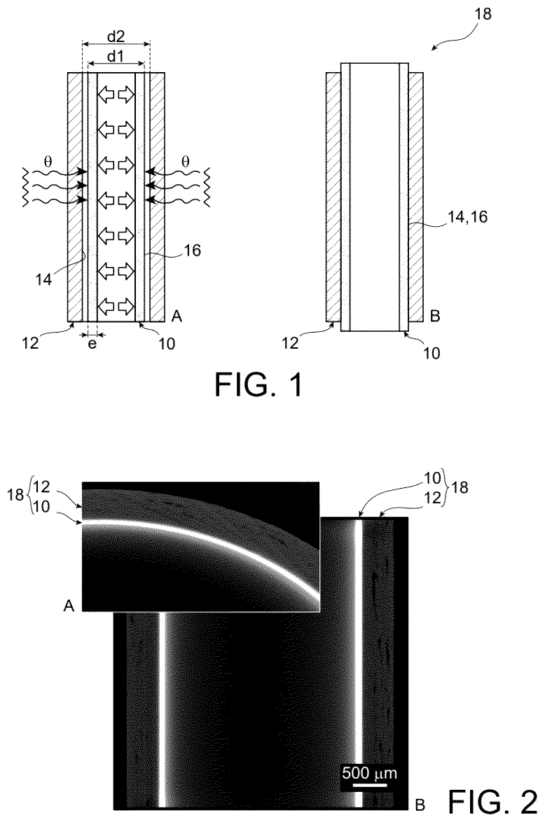

Reference is first made to FIG. 1 which schematically illustrates the principle of creep-induced plating of a tube 10 made of a metal or a metal alloy on the inner face 14 of a tube 12 made of a ceramic or a ceramic matrix composite, the tubes 10 and 12 being viewed in this figure in a longitudinal section.

As shown by part A of FIG. 1, the tube 10, of outer diameter d1, is previously inserted into the tube 12, of inner diameter d2 greater than d1, the gap existing between d1 and d2 being, preferably, chosen such that, while making it possible to insert by sliding the tube 10 into the tube 12, it can subsequently be readily filled by creep of the tube 10. Thus, the gap is, preferably, between around ten micrometres and one millimetre.

The creep of the tube 10 is obtained under the effect of the application, on the inner face of the tube 10, of a pressure, preferably isostatic as symbolised by the rectilinear white arrows, so that this pressure and, hence, the creep are the same at all points of this tube. The application of this pressure is associated with a heating of the tube 10, symbolised by the undulating black arrows topped with 0.

By creep, the tube 10 is radially deformed such that its outer diameter d1 increases thus resulting in its outer face 16 plating on the inner face 14 of the tube 12, irreversibly, i.e. with no possible elastic return of the metal or the metal alloy forming the tube 10. As shown in part B of FIG. 1, a bilayer tubular structure 18 is thus obtained. This structure is characterised by a cohesion between the metallic layer and the ceramic or ceramic matrix composite layer as shown in the tomography images of FIG. 2.

The creep results in a flow of the metal or the metal alloy and, thereby, by a thinning of the thickness e of the wall of the tube 10 lined by an elongation of this tube as also shown by part B of FIG. 1.

### II—Experimental Application of Creep-Induced Plating:

The data reported hereinafter are obtained for tubular test specimens made of Zircaloy-4 and tubular test specimens made of an SiC_{f}/SiC composite having been prepared within the scope of an E-ATF programme.

The dimensions of these test specimens are shown in the table hereinafter.

| | | | | Radial gap |
|---|---|---|---|---|
| | Inner Ø | Outer Ø | L | to be filled |
| Components | (mm) | (mm) | (mm) | (mm) |
| Zircaloy-4 | 7.96^{+0.02/-0.01} | 8.40^{+0.05/-0.01} | 170^{±1} | <0.030 |
| SiC_{f}/SiC | 8.45^{±0.05} | 9.49^{±0.005} | 97^{±1} | |

### II.1—Selection of Creep Conditions:

The creep conditions that may be suitable for obtaining a cohesion between the outer face of a Zircaloy-4 test specimen and the inner face of an SiC_{f}/SiC composite test specimen are determined using the creep law described in reference [2], having the formula:

$$\\ \dot{ε} {}_{{θ}_{visco}}^{i} = {A}_{i} {σ}_{θ}^{{n}_{i}} exp ( - \frac{{Q}_{i}}{{k}_{B} T} )$$

wherein:
\dot{ε}_{θ}_{_{visco}}ⁱ represents the rate of circumferential deformation considering an isochoric viscoplastic flow,
σ_{θ} represents the circumferential stress,
T represents the absolute temperature,
k_{B} represents the Boltzmann constant,
Aᵢ, Qᵢ and nᵢ are coefficients of the creep law determined experimentally for a given material,
i represents the phase transformation domain (i=α, β).

The circumferential stress is related to the viscoplastic circumferential deformation ε_{θ}_{_{visco}} according to the following relation:

$$\\ {σ}_{θ} = \frac{Δ p {D}_{{m}_{0}}}{2 {e}_{0}} {( 1 + {ε}_{{θ}_{visco}} )}^{2}$$

wherein:
σ_{θ} is as defined above;
Δp represents the pressure differential applied to the Zircaloy-4 test specimen;
Dₘ_{₀} represents the initial mean diameter of the Zircaloy-4 test specimen;
e₀ represents the initial thickness of the wall of the Zircaloy-4 test specimen.

In the application of this law, the temperature and pressure conditions are presumed to be applied uniformly on the Zircaloy-4 test specimens.

Moreover, it is taken as a postulate that the circumferential deformation to be imposed on the Zircaloy-4 test specimen must be 0.70% for the geometries in question so as to fill the radial gap initially present between the Zircaloy-4 test specimens and the SiC_{f}/SiC composite test specimens.

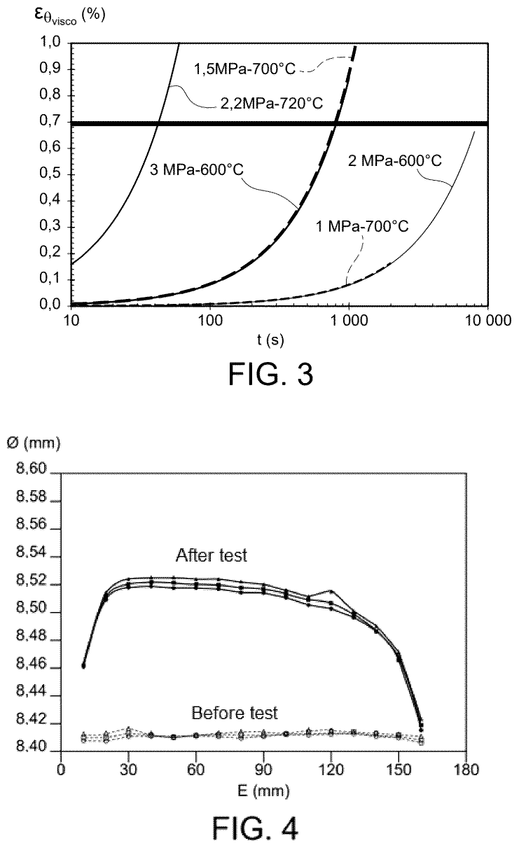

FIG. 3 illustrates in the form of curves expressing the percentage of circumferential deformation, noted Ee vis as a function of time, noted t and expressed in seconds, the results obtained for five different pressure/temperature pairs, namely:
a pressure of 1 MPa associated with a temperature of 700° C.,
a pressure of 1.5 MPa associated with a temperature of 700° C.,
a pressure of 2 MPa associated with a temperature of 600° C.,
a pressure of 2.2 MPa associated with a temperature of 720° C., and
a pressure of 3 MPa associated with a temperature of 600° C.

As shown in this figure, three pressure/temperature pairs make it possible to obtain a circumferential deformation of 0.70% in less than 1000 seconds, namely: the 2.2 MPa/720° C. pair for which deformation is obtained in 42 seconds and the 3 MPa/600° C. and 1.5 MPa/700° C. pairs for which deformation is obtained in 800 seconds.

However, it is seen from uniaxial tensile tests that applying a pressure of 3 MPa is equivalent to imposing on the SiC_{f}/SiC composite test specimens a radial stress of 56 MPa, i.e. greater than the yield strength of the composite and, therefore, capable of damaging the latter.

On the other hand, applying a pressure of 1.5 MPa or 2.2 MPa is equivalent to imposing on the SiC_{f}/SiC composite test specimens a radial stress respectively of 28 MPa and 41 MPa, i.e. less than the yield strength of the composite and, therefore, capable of preventing any damage thereof.

Therefore, creep conditions using a pressure of 1.5 MPa, on one hand, and 2.2 MPa, on the other, are tested hereinafter.

### II.2—Creep Tests on Zircaloy-4 Test Specimens Alone:

Creep tests are performed on Zircaloy-4 test specimens alone, i.e. without the presence of SiC_{f}/SiC composite test specimens, by applying a pressure of 1.5 MPa and a temperature of 700° C. for 800 seconds in order to validate these conditions experimentally.

These tests are carried out by means of a creep bench, as described in reference [2], which is adapted to grip metallic tubes. The pressure is applied uniformly on the inner face of the test specimens by intake of an inert gas whereas the test specimens are heated by Joule effect. The test specimens are disposed in an enclosure making it possible to work in a controlled atmosphere. The temperature is measured on the outer face of the test specimens by a bichromatic pyrometer, as well as inside the test specimens using a thermocouple.

A profilometry metrological inspection of the test specimens is carried out before and after the creep tests.

The results of this inspection are illustrated in FIG. 4, the dotted-line profiles corresponding to the respectively minimum, mean and maximum variations, of the outer diameter, noted Ø and expressed in mm, of the test specimens before the creep tests whereas the solid-line profiles correspond to the respectively minimum, mean and maximum variations of the same diameter following the creep tests.

This figure shows that after the creep tests, a mean increase of 1.2% of the outer diameter of the Zircaloy-4 test specimen is obtained homogeneously over a longitudinal range of approximately 120 mm, this range corresponding to the part, referred to as “usable part”, of the Zircaloy-4 test specimens to be associated with the inner wall of the SiC_{f}/SiC test specimens (see the respective lengths of the Zircaloy-4 test specimens and the SiC_{f}/SiC composite test specimens presented in the table hereinabove).

### II.3—Creep Tests on Zircaloy-4 Test Specimens in SiC_{f}/SiC Composite Test Specimens:

Similar creep tests to those described in point II.2 hereinabove are carried out with the exception that these tests are carried out on Zircaloy-4 test specimens inserted into SiC_{f}/SiC composite test specimens.

Two series of tests are carried out:
a first series by applying to the Zircaloy-4 test specimens a pressure of 1.5 MPa associated with a temperature of 700° C. for 800 seconds, and
a second series of tests by applying to the Zircaloy-4 test specimens a pressure of 2.2 MPa associated with a temperature of 720° C. for 1600 seconds; indeed, although FIG. 3 shows that for this pressure/temperature pair, 42 seconds are sufficient to obtain the radial deformation sought, a longer time is used in the second series of tests for comfort.

Here also, a profilometry metrological inspection of the test specimens is carried out before and after the creep tests.

### First Series of Tests (1.5 MPa/700° C./800 s):

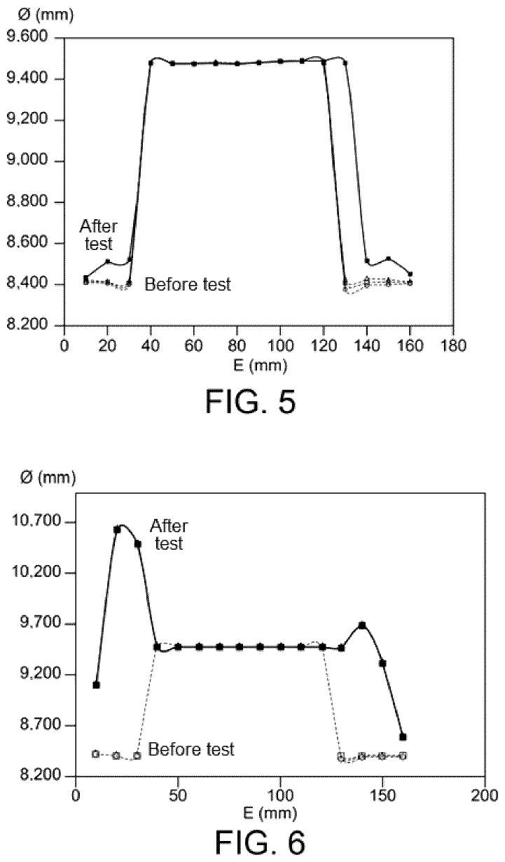

The results of the metrological inspection in this first series of tests are illustrated in FIG. 5, wherein the dotted-line profiles correspond to the respectively minimum, mean and maximum variations of the outer diameter, noted Ø and expressed in mm, of the Zircaloy-4 test specimens before the creep tests whereas the solid-line profiles correspond to the mean variations of the same diameter following the creep tests. In this figure, the variations of the outer diameter of the Zircaloy-4 test specimens are shown for the entire length of these test specimens including their usable part.

This figure shows that following the creep tests, a radial deformation of 0.97% of the Zircaloy-4 test specimens is obtained for the parts of these test specimens which are not covered by a SiC_{f}/SiC composite test specimen, which suggests that a creep-induced plating of the Zircaloy-4 test specimens at their usable part was indeed performed.

FIG. 5 also shows that the radial deformation by creep of the Zircaloy-4 test specimens has no, under the retained creep conditions, incidence on the SiC_{f}/SiC composite test specimens, the outer diameter thereof being the same before and after the creep tests.

### Second Series of Tests (2.2 MPa/720° C./1600 s):

The results of the metrological inspection in this second series of tests are illustrated in FIG. 6, wherein, here also, the dotted-line profiles correspond to the respectively minimum, mean and maximum variations of the outer diameter Ø of the Zircaloy-4 test specimens before the creep tests whereas the solid-line profiles correspond to the mean variations of the same diameter following the creep tests.

This figure shows that following the creep tests, a radial deformation of up to 27% of the Zircaloy-4 test specimens is obtained for the parts of these test specimens which are not covered by a SiC_{f}/SiC composite test specimen, which, here also, suggests that a creep-induced plating of the Zircaloy-4 test specimens at their usable part was indeed performed.

### MENTIONED REFERENCES

[1] L. Duquesne, Caractérisation thermique de structures composites SiC/SiC tubulaires pour applications nucléaires. Génie des procédés. École nationale supérieure d'arts et métiers—ENSAM, 2015
[2] T. Forgeron, et al., Experiment and Modelling of Advanced Fuel Rod Cladding Behavior Under LOCA Conditions: Alpha-Beta Phase Transformation Kinetics and EDGAR Methodology, Zirconium in the Nuclear Industry: Twelfth International Symposium, ASTM STP, 2000, 1354, 256-278

1. A method for metallizing the inner face of a tube made of a ceramic or a ceramic matrix composite, comprising at least a step of plating a metallic tube on the inner face of the ceramic or ceramic matrix composite tube, wherein the plating comprises a creep of the metallic tube by applying to this tube an internal pressure and a heating, the creep resulting in an increase in the outer diameter of the metallic tube until the outer face of this tube plates on the inner face of the ceramic or ceramic matrix composite tube.

2. The method of claim 1, wherein the application of an internal pressure to the metallic tube comprises an isostatic pressurisation of this tube.

3. The method of claim 2, wherein the isostatic pressurisation comprises an intake of a gas.

4. The method of claim 3, wherein the gas is an inert gas.

5. The method of claim 1, wherein the heating of the metallic tube is carried out by Joule effect.

6. The method of claim 1, wherein the metallic tube is made of zirconium, titanium or an alloy thereof.

7. The method of claim 6, wherein the metallic tube is made of a zirconium alloy.

8. The method of claim 1, wherein the ceramic or ceramic matrix composite tube is a tube made of silicon carbide or a silicon carbide matrix and fibrous reinforcement composite.

9. The method of claim 8, wherein the fibrous reinforcement comprises carbon fibers, silicon carbide fibers or oxide fibers.

10. The method of claim 9, wherein the fibrous reinforcement comprises silicon carbide fibers.

11. The method of claim 1, further comprising, before the plating step, an insertion of the metallic tube into the ceramic or ceramic matrix composite tube.

12. A method for manufacturing a tubular nuclear fuel cladding, the cladding comprising a layer made of ceramic matrix composite of which the inner face is coated with a metallic layer, wherein the method comprises at least a step of implementing the metallization method of claim 1.

13. The method of claim 12, wherein the ceramic matrix composite layer forms the outer face of the cladding and the metallic layer forms the inner face of the cladding.

14. The method of claim 12, wherein the ceramic matrix composite layer is a layer made of silicon carbide matrix and silicon carbide fibers and the metallic layer is a layer made of a zirconium alloy.

15. The method of claim 12, wherein the cladding is a cladding of a nuclear fuel for a light water reactor.

16. A method for manufacturing a tubular liquid or solid gas tank or a tubular propellant tank, of which the wall comprises a layer made of ceramic or ceramic matrix composite of which the inner face is coated with a metallic layer, wherein the method comprises at least a step of implementing the metallization method of claim 1.

17. The method of claim 16, wherein the ceramic or ceramic matrix composite layer forms the outer face of the tank wall and the metallic layer forms the inner face of the tank wall.
